(19) United States
(12) Patent Application Publication
(10) Pub. No.: US 2009/0042075 A1
(43) Pub. Date: Feb. 12, 2009

(54) Fuel Cell Stack

(76) Inventors: Yoshihiro Nakanishi, Utsunomiya-shi (JP); Narutoshi Sugita, Utsunomiya (JP); Masaaki Sakano, Utsunomiya-shi (JP)

Correspondence Address: LAHIVE & COCKFIELD, LLP;FLOOR 30, SUITE 3000, ONE POST OFFICE SQUARE, BOSTON, MA, 02109, US

(21) Appl. No.: 12/188,011

(22) Filed: Aug. 7, 2008

(30) Foreign Application Priority Data
Aug. 7, 2007 (JP) 2007-205831

(51) Int. Cl. H01M 8/04

(52) U.S. Cl. 429/26

(57) ABSTRACT

A fuel cell stack includes a first end power generation unit and a first dummy unit, adjacent to a power generation unit provided at one end of a stack body in a stacking direction. The first end power generation unit includes a fourth separator having the same structure as a first separator of the power generation unit, and includes a fifth separator and a sixth separator having the same structure as a second separator and a third separator. In effect, common separators are used for the fifth separator and the sixth separator by changing a pin of a molding die or changing part of a seal die.

### BACKGROUND OF THE INVENTION

1. Field of the Invention

The present invention relates to a fuel cell stack formed by stacking a plurality of power generation units. Each of the power generation units comprises first and second electrolyte electrode assemblies, and is formed by stacking a first separator, the first electrolyte electrode assembly, a second separator, the second electrolyte electrode assembly, and a third separator in this order. Each of the first and second electrolyte assemblies includes a pair of electrodes and an electrolyte interposed between the electrodes.

2. Description of the Related Art

For example, a solid polymer electrolyte fuel cell employs a solid polymer electrolyte membrane. The solid polymer electrolyte membrane is a polymer ion exchange membrane, and interposed between an anode and a cathode to form a membrane electrode assembly. The membrane electrode assembly and the separators for sandwiching the membrane electrode assembly make up a power generation cell for generating electricity. In use, typically, a predetermined number of power generation cells are stacked together to form a fuel cell stack.

In the fuel cell, a fuel gas flow field for supplying a fuel gas (hereinafter also referred to as the reactant gas) is formed on a separator surface facing the anode, and an oxygen-containing gas flow field for supplying an oxygen-containing gas (hereinafter also referred to as the reactant gas) is formed on a separator surface facing the cathode. Further, a coolant flow field for supplying a coolant is formed between surfaces of separators.

In the fuel cell stack, some of the power generation cells tend to be cooled easily by heat radiation to the outside in comparison with the other power generation cells. For example, in the power generation cells at the ends in the stacking direction, heat is radiated, e.g., from current collecting terminal plates (current collecting plates) for collecting electrical charges produced in the power generation in each of the power generation cells or from an end plate or the like for holding the stacked power generation cells. Therefore, the temperature is lowered significantly.

By the decrease in the temperature, in the end power generation cells, water condensation occurs easily, and the water produced in power generation is not discharged smoothly in comparison with the power generation cell at the center of the fuel cell stack, resulting in decrease in power generation performance.

In this regard, for example, a fuel cell stack disclosed in Japanese Laid-Open Patent Publication No. 2006-147502 is known. The fuel cell stack includes a stack body formed by stacking a plurality of power generation cells, and a dummy cell provided at least at one end of the stack body in the stacking direction. The dummy cell includes a dummy electrode assembly having an electrically conductive plate corresponding to the electrolyte, and dummy separators sandwiching the dummy electrode assembly. The dummy separator has the same structure as the separator.

In the structure, the dummy cell does not have any electrolyte, and no water is generated due to power generation. Therefore, since the dummy cell itself functions as a heat insulating layer, it is possible to effectively prevent the delay in raising the temperature of the end power generation cell at the time of warming up the fuel cell stack at low temperature, and prevent the voltage drop of the end power generation cell.

In the fuel cell stack, the coolant is provided for every predetermined number of power generation cells (e.g., skip cooling) to reduce the number of coolant flow fields, and reduce the overall size of the fuel cell stack in the stacking direction. Therefore, in the fuel cell stack having skip cooling structure, it is desired to efficiently prevent the delay in raising the temperature of the end power generation cell at the time of warming up the fuel cell stack at low temperature, and the voltage drop of the end power generation cell.

### SUMMARY OF THE INVENTION

The present invention has been made to satisfy this type of demand, and an object of the present invention is to provide a fuel cell stack including power generation units having skip cooling structure in which it is possible to equally cool the respective power generation units, and the desired power generation performance is achieved in the end power generation unit.

The present invention relates to a fuel cell stack formed by stacking a plurality of power generation units. Each of the power generation units comprises first and second electrolyte electrode assemblies, and is formed by stacking a first separator, the first electrolyte electrode assembly, a second separator, the second electrolyte electrode assembly, a third separator in this order. Each of the first and second electrolyte electrode assemblies includes a pair of electrodes and an electrolyte interposed between the electrodes. Reactant gas flow fields for reactant gases are formed on both of electrode surfaces of each of the first and second electrolyte electrode assemblies. A coolant flow field for a coolant is formed between the power generation units. Reactant gas passages and coolant passages extend through the power generation units in the stacking direction as passages of the reactant gases and the coolant.

The fuel cell stack comprises an end power generation unit adjacent to the power generation unit provided at least at one end in the stacking direction of the power generation units. The end power generation unit is formed by stacking a fourth separator, another first electrolyte electrode assembly, a fifth separator, a dummy electrolyte electrode assembly, and a sixth separator in this order from the power generation unit. The fourth separator has the same structure as the first separator, and the sixth separator is formed by providing a seal member in the third separator, for blocking communication between the coolant flow field and the coolant passages.

In the present invention, the end power generation unit is provided at least at one end in the stacking direction of the power generation units, and the end power generation cell includes a dummy electrolyte electrode assembly to limit heat radiation from the end of the stack body. Thus, in the fuel cell stack having skip cooling structure, the desired power generation performance and the power generation stability are maintained in all of the power generation units in the stacking direction.

Further, the fourth separator of the end power generation unit uses the first separator of the power generation unit, and the sixth separator is obtained by providing the seal member for blocking communication between the coolant flow field and the coolant passages in the third separator. Thus, the number of types of separators in the entire fuel cell stack is reduced, and the fuel cell stack has economical structure.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view showing a fuel cell stack according to a first embodiment of the present invention;

FIG. 2 is an exploded perspective view schematically showing a power generation unit of the fuel cell stack;

FIG. 3 is a cross sectional view showing main components of the fuel cell stack;

FIG. 4 is a front view showing a first separator of the power generation unit;

FIG. 5 is a front view showing a second separator of the power generation unit;

FIG. 6 is a front view showing a third separator of the power generation unit;

FIG. 7 is an exploded perspective view schematically showing a first end power generation unit of the fuel cell stack;

FIG. 8 is a cross sectional view showing main components of a fuel cell stack according to a second embodiment of the present invention;

FIG. 9 is a front view showing a sixth separator of a power generation unit of the fuel cell stack;

FIG. 10 is a cross sectional view showing main components of a fuel cell stack according to a third embodiment of the present invention; and

FIG. 11 is a cross sectional view showing main components of a fuel cell stack according to a fourth embodiment of the present invention.

### DESCRIPTION OF THE PREFERRED EMBODIMENTS

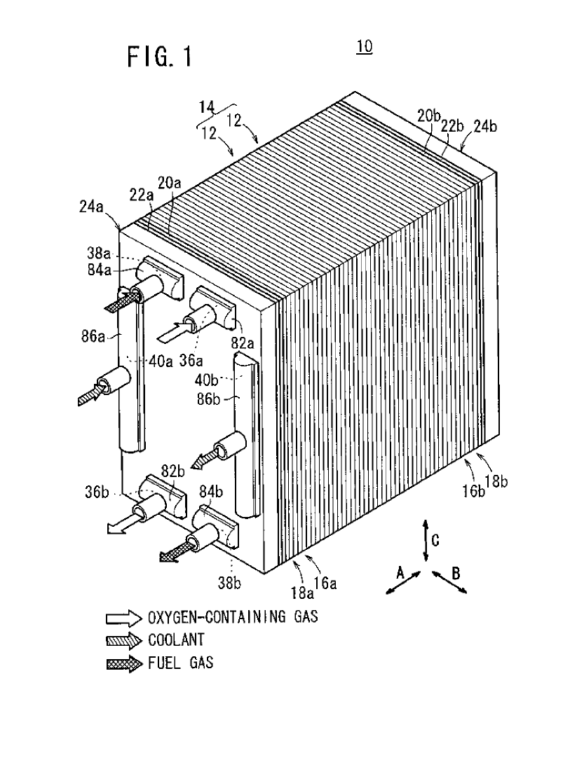

As shown in FIG. 1, a fuel cell stack 10 includes a stack body 14 formed by stacking a plurality of power generation units 12 in a direction indicated by an arrow A. At one end of the stack body 14 in a stacking direction, a first end power generation unit 16a is provided, and a first dummy unit 18a is provided outside the first end power generation unit 16a. At the other end of the stack body 14 in the stacking direction, a second end power generation unit 16b is provided, and a second dummy unit 18b is provided outside the second end power generation unit 16b. Terminal plates 20a, 20b are provided outside the first and second dummy units 18a, 18b, insulating plates 22a, 22b are provided outside the terminal plates 20a, 20b, and end plates 24a, 24b are provided outside the insulating plates 22a, 22b.

For example, components of the fuel cell stack 10 are held together by a box-shaped casing (not shown) formed by the end plates 24a, 24b each having a rectangular shape. Alternatively, components of the fuel cell stack 10 are tightened together by a plurality of tie-rods (not shown) extending in the direction indicated by the arrow A.

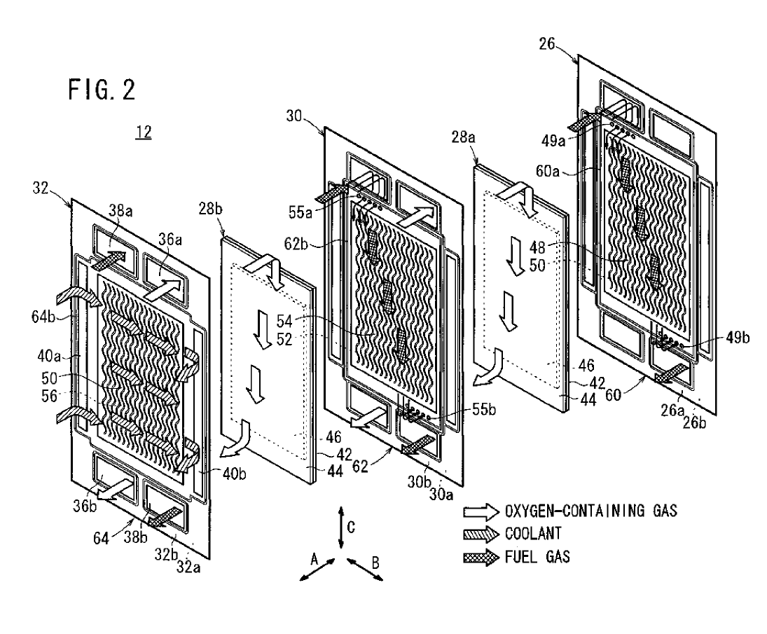

As shown in FIG. 2, the power generation unit 12 is formed by stacking a first separator 26, a first membrane electrode assembly 28a, a second separator 30, a second membrane electrode assembly 28b, and a third metal separator 32 in this order in the direction indicated by the arrow A. Each of the first separator 26, the second separator 30, and the third separator 32 has ridges and grooves in cross section by corrugating a metal thin plate under pressure.

For example, the first separator 26, the second separator 30, and the third separator 32 are steel plates, stainless steel plates, aluminum plates, plated steel sheets, or metal plates having anti-corrosive surfaces by surface treatment. Alternatively, instead of the metal separators, carbon member may be used as the first separator 26, the second separator 30, and the third separator 32.

At an upper end of the power generation unit 12 in a longitudinal direction indicated by an arrow C, an oxygen-containing gas supply passage 36a for supplying an oxygen-containing gas and a fuel gas supply passage 38a for supplying a fuel gas such as a hydrogen-containing gas are provided. The oxygen-containing gas supply passage 36a and the fuel gas supply passage 38a extend through the power generation unit 12 in the direction indicated by the arrow A.

At a lower end of the power generation unit 12 in the longitudinal direction indicated by the arrow C, a fuel gas discharge passage 38b for discharging the fuel gas and an oxygen-containing gas discharge passage 36b for discharging the oxygen-containing gas are provided. The fuel gas discharge passage 38b and the oxygen-containing gas discharge passage 36b extend through the power generation unit 12 in the direction indicated by the arrow A.

At one end of the power generation unit 12 in a lateral direction indicated by an arrow B, a coolant supply passage 40a for supplying a coolant is provided. At the other end, a coolant discharge passage 40b for discharging the coolant is provided. The coolant supply passage 40a and the coolant discharge passage 40b extend through the power generation unit 12 in the direction indicated by the arrow A.

Each of the first and second membrane electrode assemblies 28a, 28b includes a cathode 44 and an anode 46, and a solid polymer electrolyte membrane 42 interposed between the cathode 44 and the anode 46. The solid polymer electrolyte membrane 42 is formed by impregnating a thin membrane of perfluorosulfonic acid with water, for example. The surface area of the anode 46 is smaller than the surface area of the cathode 44.

Each of the cathode 44 and the anode 46 has a gas diffusion layer (not shown) such as a carbon paper, and an electrode catalyst layer (not shown) of platinum alloy supported on porous carbon particles. The carbon particles are deposited uniformly on the surface of the gas diffusion layer. The electrode catalyst layer of the cathode 44 and the electrode catalyst layer of the anode 46 are fixed to both surfaces of the solid polymer electrolyte membrane 42, respectively.

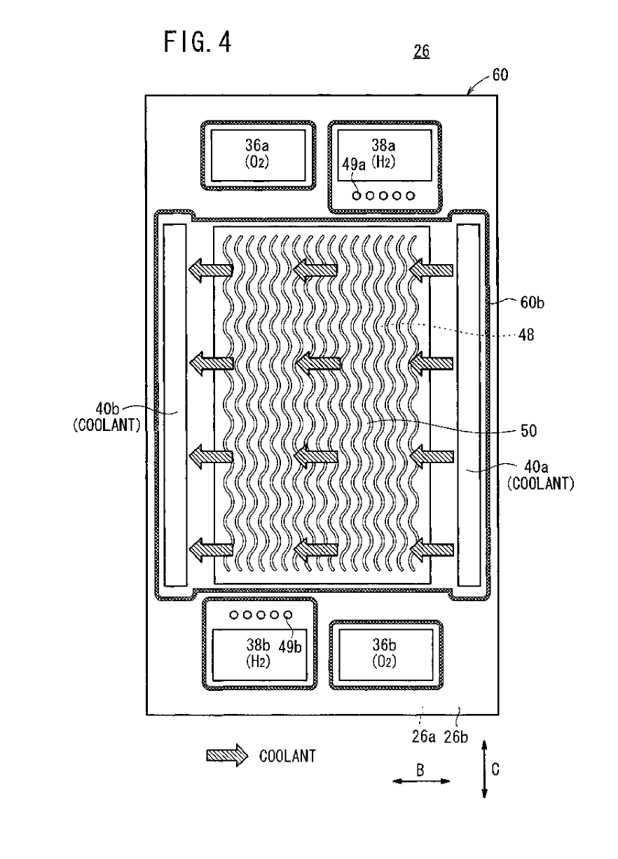

The first separator 26 has a first fuel gas flow field (reactant gas flow field) 48 on its surface 26a facing the first membrane electrode assembly 28a. The first fuel gas flow field 48 is connected to the fuel gas supply passage 38a and the fuel gas discharge passage 38b. The first fuel gas flow field 48 includes a plurality of corrugated flow grooves extending in the direction indicated by the arrow C. A plurality of inlet holes 49a extend through the first separator 26 at positions near an inlet of the first fuel gas flow field 48 and a plurality of outlet holes 49b extend through the first separator 26 at positions near an outlet of the first fuel gas flow field 48 in the stacking direction. A coolant flow field 50 is formed on a surface 26b of the first separator 26. The coolant flow field 50 is connected to the coolant supply passage 40a, and connected to the coolant discharge passage 40b (see FIG. 4).

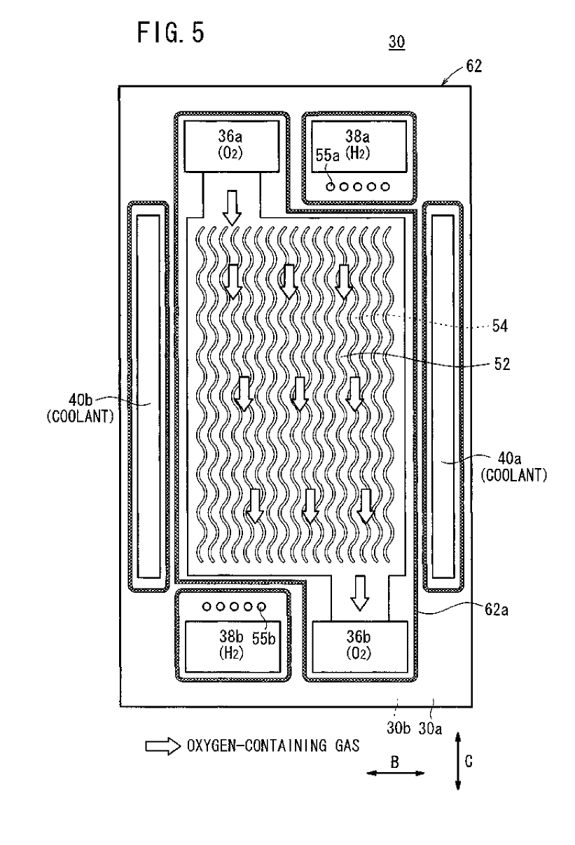

As shown in FIG. 5, the second separator 30 has a first oxygen-containing gas flow field (reactant gas flow field) 52 on its surface 30a facing the first membrane electrode assembly 28a. The first oxygen-containing gas flow field 52 comprises a plurality of corrugated flow grooves extending in the direction indicated by the arrow C.

As shown in FIG. 2, the second separator 30 has a second fuel gas flow field (reactant gas flow field) 54 on its surface 30b facing the second membrane electrode assembly 28b. The second fuel gas flow field 54 is connected to the fuel gas supply passage 38a and the fuel gas discharge passage 38b. The second fuel gas flow field 54 comprises a plurality of corrugated flow grooves extending in the direction indicated by the arrow C. A plurality of inlet holes 55a extend through the second separator 30 at positions near an inlet of the second fuel gas flow field 54 and a plurality of outlet holes 55b extend through the second separator 30 at positions near an outlet of the second fuel gas flow field 54 in the stacking direction.

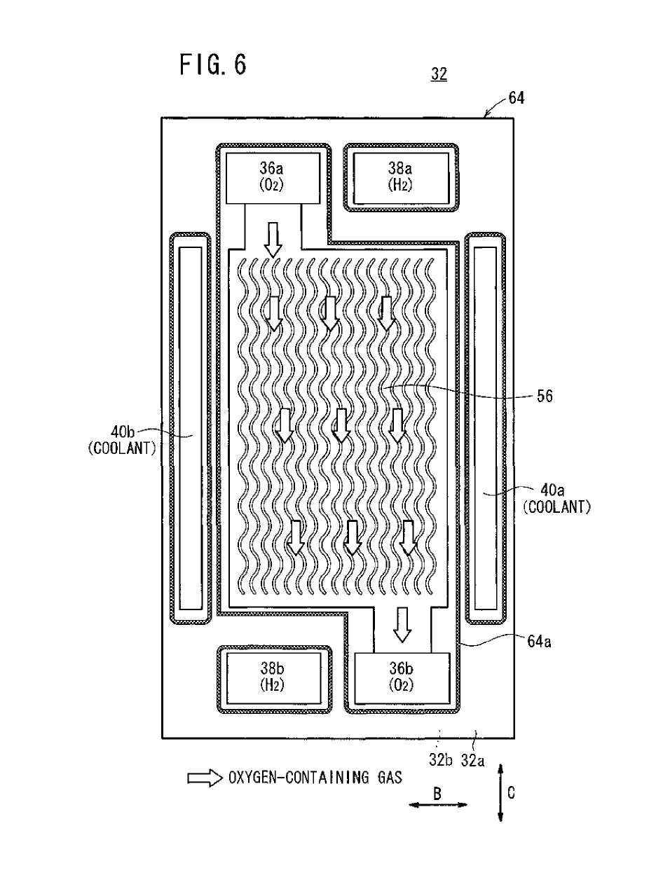

As shown in FIG. 6, the third separator 32 has a second oxygen-containing gas flow field (reactant gas flow field) 56 on its surface 32a facing the second membrane electrode assembly 28b. The second oxygen-containing gas flow field 56 is connected to the oxygen-containing gas supply passage 36a and the oxygen-containing gas discharge passage 36b. The coolant flow field 50 is formed on a surface 32b of the third separator 32. The coolant flow field 50 is connected to the coolant supply passage 40a and the coolant discharge passage 40b (see FIG. 2).

A first seal member 60 is formed integrally on the surfaces 26a, 26b of the first separator 26, around the outer end of the first separator 26. A second seal member 62 is formed integrally on the surfaces 30a, 30b of the second separator 30, around the outer end of the second separator 30. Further, a third seal member 64 is formed integrally on the surfaces 32a, 32b of the third separator 32, around the outer end of the third separator 32. Each of the first to third seal members 60, 62, 64 is made of seal material, cushion material, or packing material such as an EPDM (ethylene propylene diene monomer), an NBR (nitrile butadiene rubber), a fluoro rubber, a silicone rubber, a fluorosilicone rubber, a butyl rubber, a natural rubber, a styrene rubber, a chloroprene rubber, or an acrylic rubber.

As shown in FIG. 2, the first seal member 60 includes a ridge seal 60a on the surface 26a of the first separator 26. The ridge seal 60a is formed around the first fuel gas flow field 48, the inlet holes 49a, and the outlet holes 49b. As shown in FIG. 4, the first seal member 60 includes a ridge seal 60b. The ridge seal 60b is formed around the coolant flow field 50, the coolant supply passage 40a, and the coolant discharge passage 40b.

As shown in FIG. 5, the second seal member 62 includes a ridge seal 62a on the surface 30a of the second separator 30. The ridge seal 62a is formed around the first oxygen-containing gas flow field 52, the oxygen-containing gas supply passage 36a, and the oxygen-containing gas discharge passage 36b. As shown in FIG. 2, the second seal member 62 includes a ridge seal 62b on the surface 30b of the second separator 30. The ridge seal 62b is formed around the second fuel gas flow field 54, the inlet holes 55a, and the outlet holes 55b.

As shown in FIG. 6, the third seal member 64 includes a ridge seal 64a on the surface 32a of the third separator 32. The ridge seal 64a is formed around the second oxygen-containing gas flow field 56, the oxygen-containing gas supply passage 36a, and the oxygen-containing gas discharge passage 36b. As shown in FIG. 2, the third separator 32 includes a ridge seal 64b on the surface 32b of the third separator 32. The ridge seal 64b is formed around the coolant flow field 50, the coolant supply passage 40a, and the coolant discharge passage 40b.

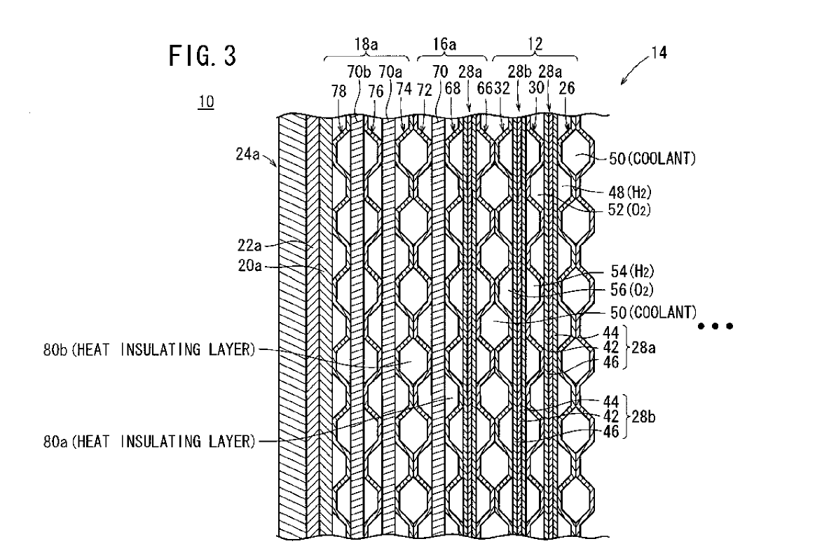

As shown in FIG. 3, the first end power generation unit 16a is formed by stacking a fourth separator 66, the first membrane electrode assembly 28a, a fifth separator 68, an electrically conductive plate (dummy electrolyte electrode assembly) 70, and a sixth separator 72 in this order from the power generation unit 12.

The fourth separator 66 has the same structure as the first separator 26. The fifth separator 68 and the sixth separator 72 substantially have the same structure as the second separator 30 and the third separator 32. The constitute components having the identical structure are labeled with the same reference numerals, and detailed description is omitted.

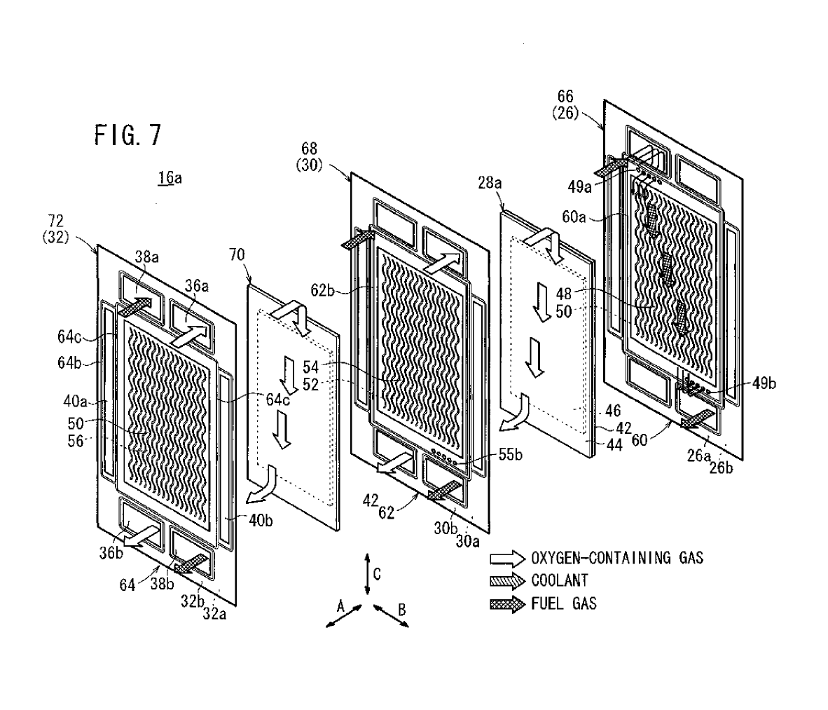

As shown in FIG. 7, the fifth separator 68 has outlet holes 55b connected to the second fuel gas flow field 54. However, no inlet holes 55a are formed in the fifth separator 68.

The third seal member 64 is provided on the sixth separator 72, and the third seal member 64 includes a seal 64c on a surface 32b of the sixth separator 72 for blocking communication among the coolant flow field 50, the coolant supply passage 40a and the coolant discharge passage 40b.

As shown in FIG. 3, the first dummy unit 18a is formed by stacking a seventh separator 74, a first electrically conductive plate (first dummy electrolyte electrode assembly) 70a, an eighth separator 76, a second electrically conductive plate (second dummy electrolyte electrode assembly) 70b, and a ninth separator 78 in this order from the first end power generation unit 16a.

The seventh separator 74 has the same structure as the first separator 26. The eighth separator 76 and the ninth separator 78 have the same structure as the second separator 30 and the third separator 32. It should be noted that, in the seventh separator 74, the first seal member 60 may have a ridge seal (not shown) on the surface 26b for blocking communication among the coolant flow field 50, the coolant supply passage 40a and the coolant discharge passage 40b.

For example, the electrically conductive plate 70, the first electrically conductive plate 70a, and the second electrically conductive plate 70b have the thickness equal to the thickness of the first membrane electrode assembly 28a, and do not have the power generation function.

In the first end power generation unit 16a, a first heat insulation layer 80a is formed between the fifth separator 68 and the electrically conductive plate 70, at a position corresponding to the second fuel gas flow field 54, by limiting the flow of the fuel gas. A second heat insulating layer 80b is formed between the first end power generation unit 16a and the first dummy unit 18a, at a position corresponding to the coolant flow field 50, by limiting the flow of the coolant.

As shown in FIG. 1, at upper and lower opposite ends of the end plate 24a, an oxygen-containing gas inlet manifold 82a, a fuel gas inlet manifold 84a, an oxygen-containing gas outlet manifold 82b, and a fuel gas outlet manifold 84b are provided. The oxygen-containing gas inlet manifold 82a is connected to the oxygen-containing gas supply passage 36a, the fuel gas inlet manifold 84a is connected to the fuel gas supply passage 38a, the oxygen-containing gas outlet manifold 82b is connected to the oxygen-containing gas discharge passage 36b, and the fuel gas outlet manifold 84b is connected to the fuel gas discharge passage 38b.

At left and right opposite ends of the end plate 24a, a coolant inlet manifold 86a and a coolant outlet manifold 86b are provided. The coolant inlet manifold 86a is connected to the coolant supply passage 40a, and the coolant outlet manifold 86b is connected to the coolant discharge passage 40b.

Operation of the fuel cell stack 10 will be described below.

Firstly, as shown in FIG. 1, in the fuel cell stack 10, an oxygen-containing gas is supplied to the oxygen-containing gas inlet manifold 82a, a fuel gas such as a hydrogen-containing gas is supplied to the fuel gas inlet manifold 84a, and coolant such as pure water or ethylene glycol is supplied to the coolant inlet manifold 86a.

As shown in FIG. 2, the oxygen-containing gas flows from the oxygen-containing gas supply passage 36a of each power generation unit 12 into the first oxygen-containing gas flow field 52 of the second separator 30 and the second oxygen-containing gas flow field 56 of the third separator 32. Thus, the oxygen-containing gas flows downwardly along the respective cathodes 44 of the first and second membrane electrode assemblies 28a, 28b.

The fuel gas flows from the fuel gas supply passage 38 of each power generation unit 12 to the first fuel gas flow field 48 of the first separator 26 and the second fuel gas flow field 54 of the second separator 30. Thus, the fuel gas flows downwardly along the respective anodes 46 of the first and second membrane electrode assemblies 28a, 28b.

As described above, in each of the first and second membrane electrode assemblies 28a, 28b, the oxygen-containing gas supplied to the cathode 44 and the fuel gas supplied to the anode 46 are consumed in the electrochemical reactions at catalyst layers of the cathode 44 and the anode 46 for generating electricity.

Then, the oxygen-containing gas consumed at the cathode 44 is discharged from the oxygen-containing gas discharge passage 36b to the oxygen-containing gas outlet manifold 82b (see FIG. 1). Likewise, the fuel gas consumed at the anode 46 is discharged from the fuel gas discharge passage 38b to the fuel gas outlet manifold 84b.

Further, as shown in FIGS. 2 and 3, the coolant flows into the coolant flow field 50 formed between the power generation units 12. The coolant flows in the horizontal direction indicated by the arrow B in FIG. 2, and cools the second membrane electrode assembly 28b of one of the adjacent power generation units 12, and cools the first membrane electrode assembly 28a of the other of the adjacent power generation units 12. That is, the coolant does not cool the space between in the first and second membrane electrode assemblies 28a, 28b inside one power generation unit 12, for performing skip cooling. Thereafter, the coolant is discharged from the coolant discharge passage 40b into the coolant outlet manifold 86b.

In the first embodiment, as shown in FIG. 3, the first end power generation unit 16a is provided adjacent to the power generation unit 12 at one end of the stack body 14 in the stacking direction. The first end power generation unit 16a includes the fourth separator 66, the first membrane electrode assembly 28a, the fifth separator 68, the electrically conductive plate 70, and the sixth separator 72 in this order from the power generation unit 12.

In the structure, when the coolant is supplied to the coolant flow field 50 formed between the power generation unit 12 and the first end power generation unit 16a, the coolant cools the second membrane electrode assembly 28b of the power generation unit 12 and the first membrane electrode assembly 28a of the first end power generation unit 16a.

In each of the power generation units 12, the coolant is supplied to the coolant flow field 50 formed between the power generation units 12. Thus, the second membrane electrode assembly 28b and the first membrane electrode assembly 28a positioned on both sides of the coolant flow field 50 are cooled by the coolant.

Accordingly, in both the power generation unit 12 provided at the center in the stacking direction and the power generation unit 12 provided at the outermost end in the stacking direction, i.e., the power generation unit 12 adjacent to the first end power generation unit 16a, the coolant flowing through the single coolant flow field 50 cools the first and second membrane electrode assemblies 28a, 28b on both sides of the coolant flow field 50. In the structure, heat generation and cooling are balanced equally.

Further, the first heat insulating layer 80a is formed by limiting the flow of the fuel gas in the first end power generation unit 16a, and the second heat insulating layer 80b is formed between the first end power generation unit 16a and the first dummy unit 18a. Thus, heat radiation from the outermost end in the stacking direction of the stack body 14 to the outside is prevented further reliably.

Further, in the first embodiment, as shown in FIGS. 2 and 7, the fourth separator 66 of the first end power generation unit 16a has the same structure as the first separator 26, and the fifth separator 68 and the sixth separator 72 have substantially the same structure as the second separator 30 and the third separator 32.

Specifically, the second separator 30 and the fifth separator 68 can be fabricated using the same molding die. That is, the inlet holes 55a are formed using a pin member for punching through the second separator 30, whereas the inlet holes 55a are not formed in the fifth separator 68.

Further, the third separator 32 and the sixth separator 72 can be fabricated using the same molding die, while partially changing the seal molding die. That is, the sixth separator 72 can be formed simply by modifying the third seal member 64 to include the additional seal 64c for blocking communication among the coolant flow field 50, the coolant supply passage 40a and the coolant discharge passage 40b. Thus, the first end power generation unit 16a has the same structure as the power generation unit 12, and no dedicated separator is required.

Likewise, in the first dummy unit 18a, the second separator 30 and the third separator 32 can be used as the eighth separator 76 and the ninth separator 78. The seventh separator 74 can be fabricated simply by partially modifying the first seal member 60 as necessary, as in the case of the sixth separator 72. In effect, the first separator 26 is used as the seventh separator 74.

In the second end power generation unit 16b and the second dummy unit 18b, the same advantages as in the cases of the first end power generation unit 16a and the first dummy unit 18a can be obtained.

In the fuel cell stack 10 having skip cooling structure according to the first embodiment, in effect, only three types of separators, i.e., the first separator 26, the second separator 30, and the third separator 32 are provided, and the fuel cell stack 10 has economical structure.

Further, the fifth separator 68 has the outlet holes 55b. In the structure, at the time of interrupting the flow of the fuel gas in the second fuel gas flow field 54, water is not retained in the second fuel gas flow field 54. The water is discharged reliably from the outlet holes 55b.

Further, in the first dummy unit 18a, the fuel gas is supplied to the first and second fuel gas flow fields 48, 54 all the time. Further, the oxygen-containing gas is supplied to the first and second oxygen-containing gas flow fields 52, 56 all the time. Therefore, the water is discharged from the flow grooves smoothly, and freezing of retained water or the like is prevented reliably.

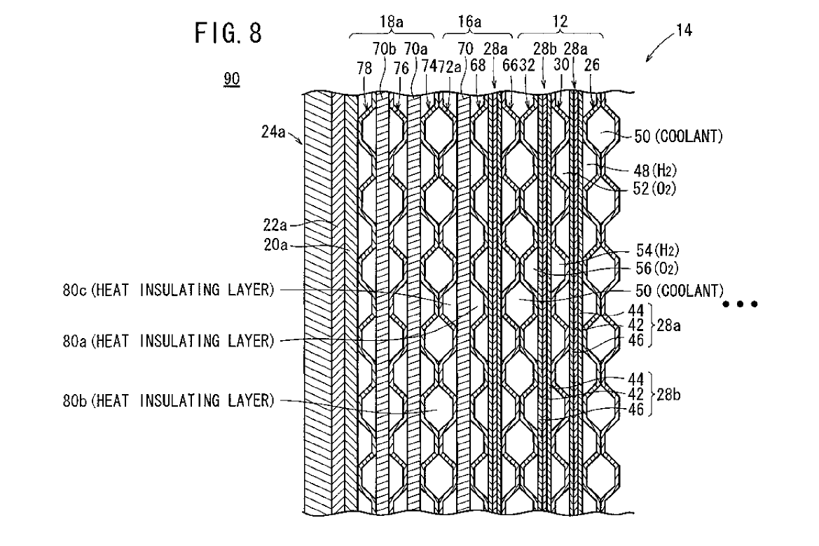

FIG. 8 is a cross sectional view showing main components of a fuel cell stack 90 according to a second embodiment of the present invention. The constituent elements that are identical to those of the fuel cell stack 10 according to the first embodiment are labeled with the same reference numerals, and detailed description will be omitted. Further, also in third and fourth embodiments, the constituent elements that are identical to those of the fuel cell stack 10 according to the first embodiment are labeled with the same reference numerals, and detailed description will be omitted.

The fuel cell stack 90 includes a first end power generation unit 16a adjacent to the power generation power generation unit 12 provided at one end in the stacking direction of the stack body 14, and a first dummy unit 18a adjacent to the first end power generation unit 16a. In the end power generation unit 16a, a third heat insulating layer 80c are provided by liming the flow of the oxygen-containing gas into the second oxygen-containing gas flow field 56 formed between an electrically conductive plate 70 and a sixth separator 72a.

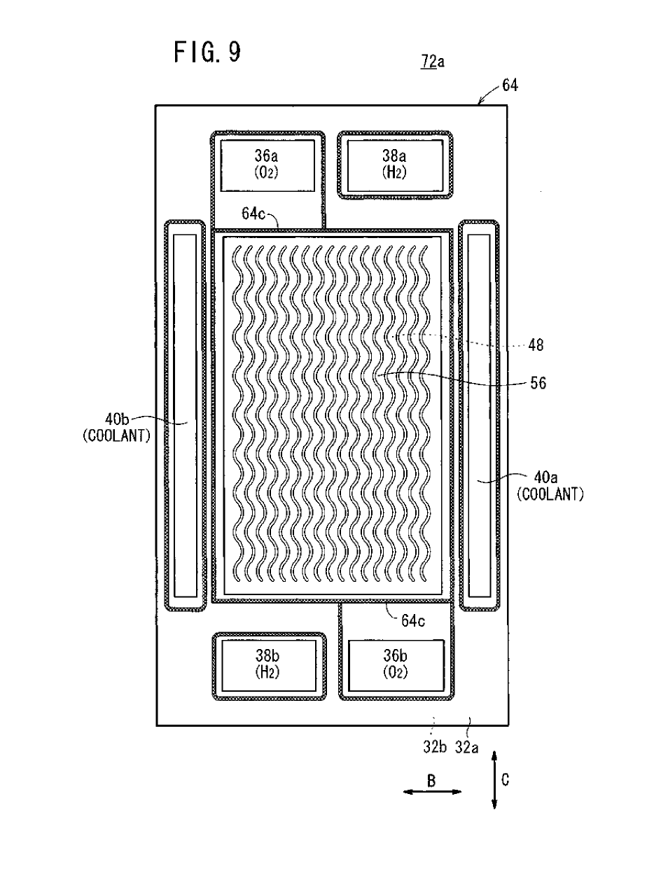

Specifically, as shown in FIG. 9, the third seal member 64 includes a seal 64c on a surface 32a of the sixth separator 72a. The seal 64c blocks communication among the second oxygen-containing gas flow field 56, the oxygen-containing gas supply passage 36a and the oxygen-containing gas discharge passage 36b.

In the second embodiment, at least at the one end of the stack body 14 in the stacking direction, in addition to the first and second heat insulating layers 80a, 80b, the third heat insulating layer 80c is provided. In the structure, further improvement in heat insulating performance is achieved advantageously.

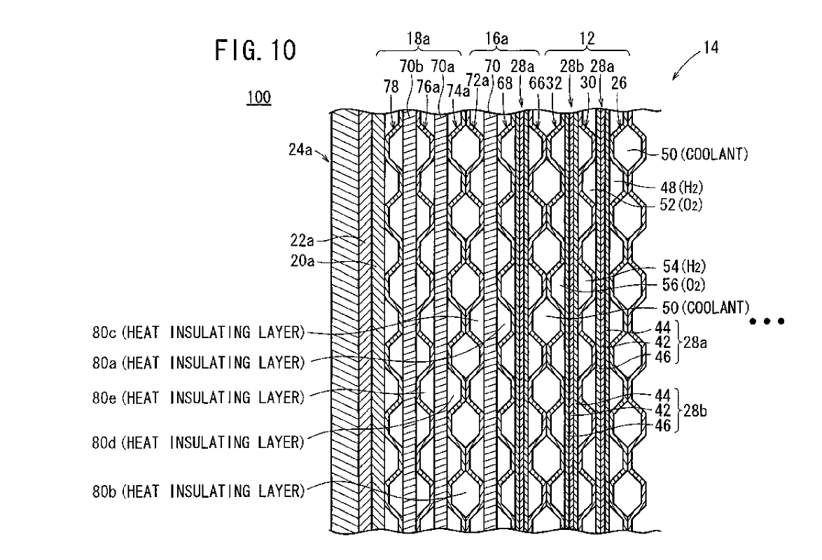

FIG. 10 is a cross sectional view showing main components of a fuel cell stack 100 according to a third embodiment of the present invention.

The fuel cell stack 100 includes a first end power generation unit 16a and a first dummy unit 18a. In the first dummy unit 18a, fourth and fifth heat insulating layers 80d, 80e are formed on both sides of a first electrically conductive plate 70a, at positions corresponding to the first fuel gas flow field 48 and the first oxygen-containing gas flow field 52, by limiting the flows of the fuel gas and the oxygen-containing gas.

Specifically, the seventh separator 74a has the same structure as the fifth separator 68, and the eighth separator 76a has the same structure as the sixth separator 72a. Therefore, in the third embodiment, the first to fifth heat insulating layers 80a to 80e are provided at least at one end of the stack body 14 in the stacking direction.

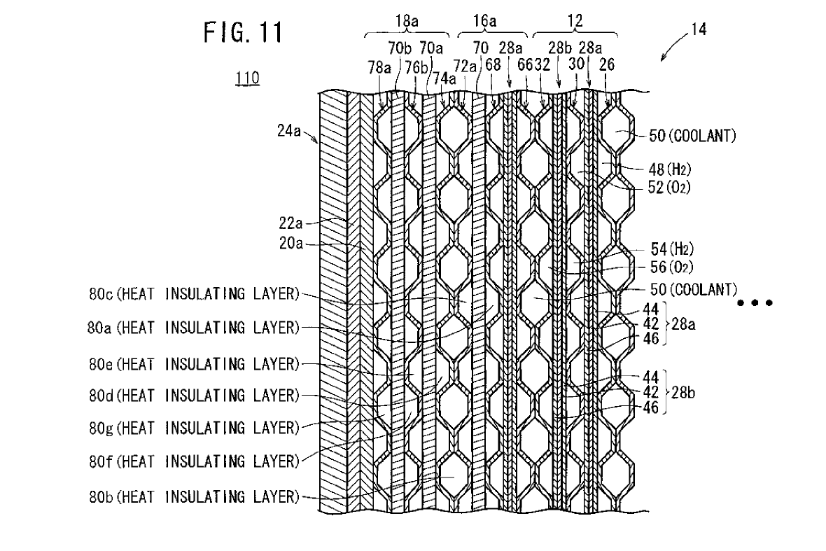

FIG. 11 is a cross sectional view showing main components of a fuel cell stack 110 according to a fourth embodiment of the present invention.

In the first dummy unit 18a of the fuel cell stack 110, sixth and seventh heat insulating layers 80f, 80g are also provided on both sides of the second electrically conductive plate 70b, at positions corresponding to the second fuel gas flow field 54 and the second oxygen-containing gas flow field 56, by limiting the flows of the fuel gas and the oxygen-containing gas, respectively.

Specifically, the eighth separator 76b does not have the inlet holes 55a. The ninth separator 78a has the same structure as the sixth separator 72a. Thus, in the fourth embodiment, the first to seventh heat insulating layers 80a to 80g are provided at least at one end of the stack body 14 in the stacking direction. Accordingly, improvement in the heat insulating performance is achieved further reliably.

In the first to fourth embodiments, though the power generation unit 12 has skip cooling structure for cooling every two cells, the present invention is not limited in this respect. Alternatively, the power generation unit 12 may have skip cooling structure for cooling, e.g., every three cells.

While the invention has been particularly shown and described with reference to the preferred embodiments, it will be understood that variations and modifications can be effected thereto by those skilled in the art without departing from the spirit and scope of the invention as defined by the appended claims.

What is claimed is:

1. A fuel cell stack formed by stacking a plurality of power generation units, the power generation units each comprising first and second electrolyte electrode assemblies, and being formed by stacking a first separator, the first electrolyte electrode assembly, a second separator, the second electrolyte electrode assembly, a third separator in this order, the first and second electrolyte electrode assemblies each including a pair of electrodes and an electrolyte interposed between the electrodes, reactant gas flow fields for reactant gases being formed on both of electrode surfaces of each of the first and second electrolyte electrode assemblies, a coolant flow field for a coolant being formed between the power generation units, reactant gas passages and coolant passages extending through the power generation units in the stacking direction as passages of the reactant gases and the coolant,
the fuel cell stack comprising:
an end power generation unit adjacent to the power generation unit provided at least at one end in the stacking direction of the power generation units, wherein
the end power generation unit is formed by stacking a fourth separator, another first electrolyte electrode assembly, a fifth separator, a dummy electrolyte electrode assembly, and a sixth separator in this order from the power generation unit;
the fourth separator has the same structure as the first separator; and
the sixth separator is formed by providing a seal member in a separator having the same structure as the third separator, for blocking communication between the coolant flow field and the coolant passages.

2. A fuel cell stack according to claim 1, wherein the reactant gas passages include a reactant gas supply passage and a reactant gas discharge passage;
an inlet opening and an outlet opening extend through the second separator for connecting the reactant gas flow field to the reactant gas supply passage and the reactant gas discharge passage; and
the fifth separator is formed by closing the inlet opening of a separator having the same structure as the second separator.

3. A fuel cell stack according to claim 1, wherein the sixth separator is formed by providing a seal member in the separator having the same structure as the third separator, for blocking communication between the reactant gas flow field and the reactant gas passages.

4. A fuel cell stack according to claim 1, further comprising a dummy unit adjacent to the end power generation unit,
the dummy unit is formed by stacking a seventh separator, a first dummy electrolyte electrode assembly, an eighth separator, a second dummy electrolyte electrode assembly, and a ninth separator in this order from the end power generation unit.

5. A fuel cell stack according to claim 4, wherein the seventh separator, the eighth separator, and the ninth separator have the same structure as the first separator, the second separator, and the third separator, respectively.
